(19) United States
(12) Patent Application Publication
(10) Pub. No.: US 2009/0113113 A1
(43) Pub. Date: Apr. 30, 2009

(54) METHOD AND APPARATUS FOR SANITIZING OR MODIFYING FLASH MEMORY CHIP DATA

(76) Inventors: Richard Kenneth Steele, Jr., Carrollton, TX (US); Dennis Shawn Key, Arlington, TX (US); Muhammad Asim Abbasi, Irving, TX (US); Bruce C. Lutz, Richardson, TX (US)

Correspondence Address: SCHEEF & STONE, L.L.P., 500 N. Akard, Suite 2700, DALLAS, TX, 75201, US

(21) Appl. No.: 11/839,359

(22) Filed: Aug. 15, 2007

(51) Int. Cl. G06F 12/00

(52) U.S. Cl. 711/103; 711/E12.001

(57) ABSTRACT

A method and apparatus is provided for individually checking, sanitizing and/or otherwise altering data bits of a plurality of memory chips via one or more processes where the memory chips being processed at any given time may be of different unformatted memory capacities, may be of different memory types, and may have the process started at different times. The method utilizes a computer based program capable of multithreaded operation whereby a new procedure thread is initiated upon a determination by the main program that a given reader port is in recent initial communication with a memory chip.

### FIELD OF THE INVENTION

The present invention relates generally to a method of, and apparatus for, easily and quickly sanitizing, permanently deleting, and/or otherwise altering or checking previously stored data on one or more non-volatile solid state storage devices such as memory chips.

### BACKGROUND

There are numerous prior art examples of programs and devices designed to sanitize or permanently delete data from magnetically written hard and floppy discs.

There are also programs that are designed to sanitize a memory chip. As used hereinafter in this document, the term “memory chip” may refer to the type of non-volatile memory inserted in a separate reader as well as the type incorporated in a memory stick adapted to be inserted in a USB (universal serial bus) port of a computer device.

It is known that, to sanitize a hard disk, all the data bits of that disk need to be re-written with new data a plurality of times in order to prevent the possibility of recovering previously written data. The DOD (Department of Defense) has even published procedures that must be followed to sanitize a DOD hard disk.

While it is more difficult to recover previously written data from non-volatile solid state memory such as flash memory chips than it is to recover previously written data from a hard disk, there is literature on the Internet that suggests that such recovery is possible for the dedicated hacker up to at least 10 layers of previously written data in some versions of solid state memory.

There are times when it is desirable to sanitize or otherwise modify or check data stored in more than one memory chip at a given time. Businesses that rent the use of memory chips for use in conjunction with games, books and other reading material and so forth, are interested in completely removing the prior stored data before re-using the chips. Prior art patents such as U.S. Pat. Nos. 7,089,350 and 7,003,621 illustrate a method whereby a plurality of identical memory chips may be simultaneously sanitized. The method presented has each chip in a sub-array receiving identical blocks of data in parallel to decrease the total time required for sanitizing a given number of non-volatile blockwise erasable data storage media such as memory chips.

Such apparatus as discussed in the above referenced patents may be desirable in some applications where every memory chip to be sanitized is of the same memory capacity. However, there are instances where a user may desire to sanitize memory chips of different types, different capacities and may want to sanitize one or more additional memory chips before the sanitizing apparatus is finished sanitizing a given first chip or set of chips.

There are also many instances where business establishments need to monitor data taken into or out of the establishments on memory sticks or on memory chips in the form of memory cards that are readily available for cameras, cell phones, computers and similar devices.

It would thus be desirable, when sanitizing or otherwise performing a memory bit modification operation on one or more memory chips, that the device be able to accept new chips to be sanitized or otherwise operated upon while the device continues to operate upon chips previously inserted into the device. It would also be desirable to have a status light, indicator or other presentation that provides information as to the status of the one or more procedures of each memory chip that has been inserted into the device. In the situation of chip sanitizing, it would be further desirable to optionally be able to activate further routines that reformat and/or create a file directory upon the completion of a routine used to sanitize a memory chip.

### SUMMARY

The present invention, accordingly, provides a system and method which detects the insertion of new memory chips while operating to continue any prior commenced procedures of sanitizing and/or otherwise altering, adding, removing and/or checking data of previously inserted memory chips. This is accomplished by generating a new thread or subprogram to determine the characteristics (such as unformatted memory capacity and type of memory chip) of the recently inserted memory chip(s). This new thread then calls one or more programs (routines) to perform an appropriate operation such as sanitizing and/or otherwise modifying memory chip data. Optionally, the device can additionally commence further routines such as re-formatting a memory chip after a sanitizing operation, and then commencing an even further routine to insert directory file data whereby the memory chip is in condition for further use by a consumer, in one physical memory chip insertion step.

### BRIEF DESCRIPTION OF THE DRAWINGS

For a more complete understanding of one or more embodiments of the present invention and the advantages thereof, reference is now made to the following descriptions taken in conjunction with the accompanying drawings, in which:

FIG. 1 illustrates an exemplary memory chip data modification apparatus along with a display providing status data for each chip whose data is being or has been modified and specifically as shown for chip sanitation, reformatting and file and directory creation status;

FIG. 2 exemplifies, in high level form, a flow diagram of a program operation utilized in performing chip sanitization along with optional reformatting and file creation;

FIG. 3 exemplifies, in block diagram format, the components utilized altering and/or checking data in one or more memory chips and in providing procedure status indications thereof; and

FIG. 4 exemplifies, in high level form, a flow diagram of the program operation utilized in performing any type of data bit modification of a plurality of memory chips wherein the data bit modification of a new memory chip may be initiated while continuing the modification of memory chips presently being processed.

### DETAILED DESCRIPTION

As background for non-programmers of computers, it should be mentioned that the operation of a computer may comprise using a program having a main or parent thread that is able to initiate one or more child threads upon the detection or occurrence of predetermined events. These child threads may then return data to or retrieve data from the parent thread using a function or method typically termed a “delegate”. A “delegate” is actually a pointer to a function or method. When the child thread completes the actions required, it is terminated to free up computer capacity and/or permit other child threads to be initiated by the parent program.

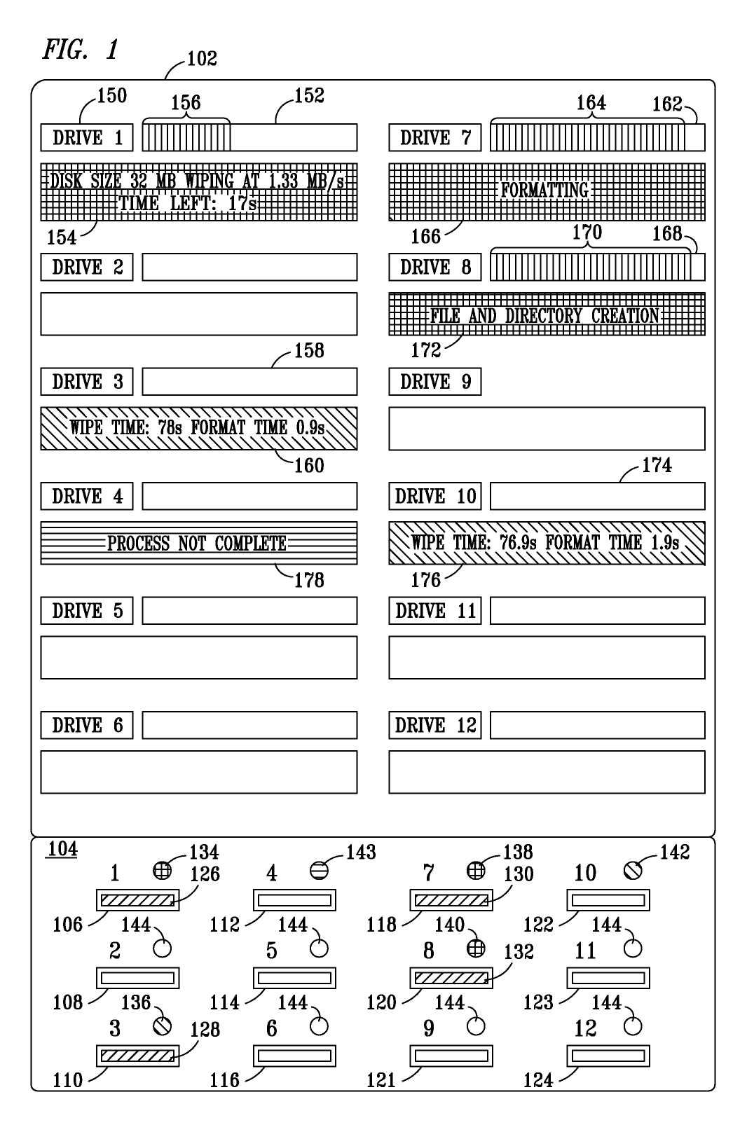

In FIG. 1, a block 102 represents a computer display, while a block 104 represents a portion of a computer device comprising as shown, ten memory chip ports or nonvolatile memory media device reader and/or writer ports designated as drives 1 through 10 and further designated sequentially as 106, 108, 110, 112, 114, 116, 118, 120, 121 and 122 respectively. Also shown are two USB ports 123 and 124 further designated as drives 11 and 12, respectively. As is known in the art, memory chip readers typically are operable to read data from an inserted memory chip as well as being operable to write data to an inserted memory chip. It should be noted that it is common practice for memory chip readers to be inserted into a USB port for signal communication with a computer or other device. The same read/write capability is typical of memory sticks which normally are configured to be inserted into a USB port.

Some of the readers, such as 106 (reader 1), 110 (reader 3), 118 (reader 7) and 120 (reader 8) are shown to contain, or have inserted therein, memory chips. Thus, as shown, a memory chip, nonvolatile media or flash memory device 126 is shown as being inserted in reader 106. Likewise, a memory chip 128 is shown inserted in reader 110, a chip 130 is inserted in reader 118 and a chip 132 is shown inserted in reader 120. A status indicator light 134 associated with reader 106 is shaded to indicate that it is in an ON condition. In one embodiment of the invention, the indicator lights on block 104 were preferably energized in the yellow condition, while a memory chip was being sanitized, formatted, and provided with a file directory.

The status light, in one embodiment of the invention, was preferably altered to a green condition upon successful completion of a sanitizing procedure, or to a red condition when the procedure was not successfully completed. As shown, status light 136 signifies a green or successful entire procedure completion for chip 128 in reader 110. Indicators 138 and 140 preferably represent an ongoing or yellow procedure for chips 130 and 132 in the same manner as indicator 134. An indicator light 142 is shown preferably representing a green condition showing that although there is no chip in reader 122, the last sanitizing operation of a chip in reader 122 was successful. An indicator 143 is exemplified as representing a red condition showing that although there is no chip in reader 112, the last sanitizing operation of a chip in reader 112 was not successful. Such an indication may occur because the chip itself was faulty, the sanitizing software made an error or (more likely) the chip was removed prematurely. That is, it was removed before the sanitization procedure was completed. The remaining indicators 144 for readers 108, 112, 114, 116 and 121 as well as for USB ports 123 and 124 are shown as being in the OFF or un-energized condition. Such a status was designed to result, in one embodiment of the invention, when a chip had not been sanitized in a given port subsequent to the sanitizing device being turned to an ON condition.

As used hereinafter, the sanitization process may also be referred to in the art as a “wiping operation”, an “erase operation”, a “permanent delete” and so forth. While one embodiment of this invention performed the sanitization portion of the procedure by writing a logic “0” to each memory bit position of the entire chip, many alternate, and usually more time consuming, procedures may be used. As mentioned above, each bit may be rewritten with consecutive logic “1”s and “0”s until the customer, or other user, is satisfied that the prior data cannot be economically retrieved by subsequent users.

Within the display block 102, each memory chip port or drive is represented by three rectangular blocks or objects. As exemplified, a first object 150 provides an indication of the memory chip port numerical designation, a second object 152 preferably provides an indicator, such as a dash bar graph type presentation, of the time to completion of the sanitizing operation, and a third object 154 preferably provides a text description of the status of a chip being sanitized along with a background yellow color similar in nature to the corresponding status indicator adjacent a given memory chip reader in block 104. A bar graph 156, exemplified as extending approximately ½ the length of object 152 thus provides an indication that the total sanitization procedure for the chip 126 in reader 106 (drive 1) is about ½ completed. As stated within object 154, by way of example, the chip memory capacity (or non-volatile memory size) is 32 MB (megabytes) and the approximate time to completion of the sanitization procedure is estimated to be about 17 seconds.

An object 158 that would provide completion time for the chip 128 of reader 110 (drive 3) is clear thereby indicating that no action is presently taking place with respect to the memory chip 128. As indicated in object 160, by way of example, the “Wipe Time” for chip 128 was 78 seconds while the formatting time was 0.9 seconds. The background of object 160 is preferably representative of green thereby indicating that the wiping or sanitization procedure was successful as shown previously mentioned in conjunction with status indicator 136.

An object 162, containing an indicator, such as a bar graph 164, provides an indication that the sanitization procedure of memory chip 130 is nearly complete. As further indicated in an object 166, also associated with reader 118 and the inserted chip 130, the optional formatting of the chip is occurring. The background of object 166 is preferably the same color yellow as was object 154 and the status light 138, thereby indicating that the procedure is ongoing and without error.

An object 168, containing an indicator, such as a bar graph 170, provides an indication that the sanitization, formatting and file creation procedure of memory chip 132 is also nearly complete. As further indicated in an object 172, also associated with reader 120 and the inserted chip 132, the optional file and directory creation of the chip is occurring. The background of object 172 is preferably the same color yellow as was object 154 and the status light 140, thereby indicating that the procedure is so far successful.

As previously mentioned, there is no chip in reader 122 (drive 10). An associated display or procedure completion bar container object 174 is blank. A further associated display object 176 provides, by way of example, a text indication of wipe or sanitization time being 76.9 seconds and the formatting time being 1.9 seconds. Even where two chips being sanitized are the same total capacity, the times for identical procedures may well be different when the microprocessor being used to run the sanitizing program is otherwise temporarily occupied. As will be noted, by way of example, the formatting for the chip previously inserted in drive 10 took 1.9 seconds to be formatted while the chip 128 was formatted in only 0.9 seconds according to the text in objects 176 and 160 of display 102.

As may be noted, there is no chip shown inserted in reader 112 (drive 4). A text message in an associated display object 178 preferably provides an indication that the sanitization process was not complete and the background shading is indicative of red as was the status light indicator 143.

The remaining objects in display block 102 for ports or drives 2, 5, 6, 9, 11 and 12 are shown clear as they have not been utilized to sanitize a chip since the sanitizing device was activated to an ON condition.

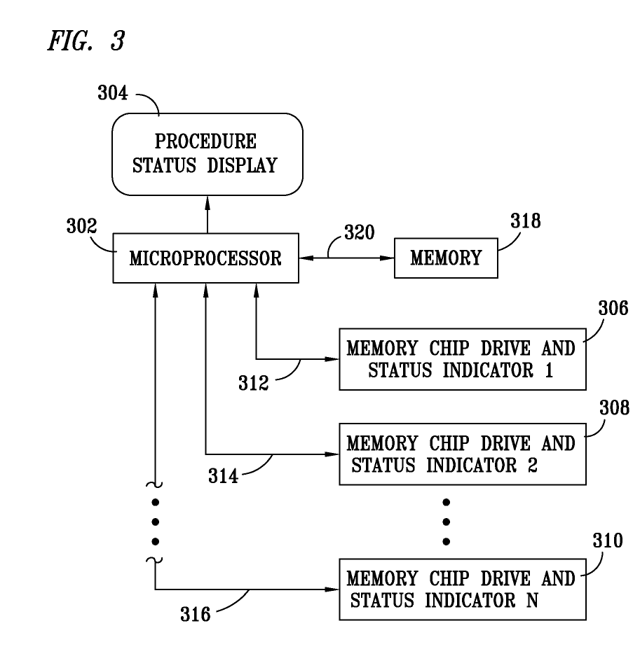

Reference will now be made to FIG. 3. A microprocessor or other control means 302 is shown supplying data to a display 304 corresponding to display block 102 of FIG. 1. Memory chip drive blocks 306, 308 and 310 are shown as representing 1st, 2nd and Nth memory chip reading device ports respectively. As will be apparent, any number of further ports, in accordance with the capabilities of the processor 302 may be added between blocks 308 and 310. A two-way data path 312 provides communication between the microprocessor 302 and block 306. Similarly, data paths 314 and 316 provide communication between microprocessor 302 and the blocks 308 and 310 respectively. A block 318 represents any memory utilized by microprocessor 302 whether in the form of hard drives, floppy discs, external drives or cache memory internal to microprocessor 302. A communication data path 320 is shown between blocks 302 and 318.

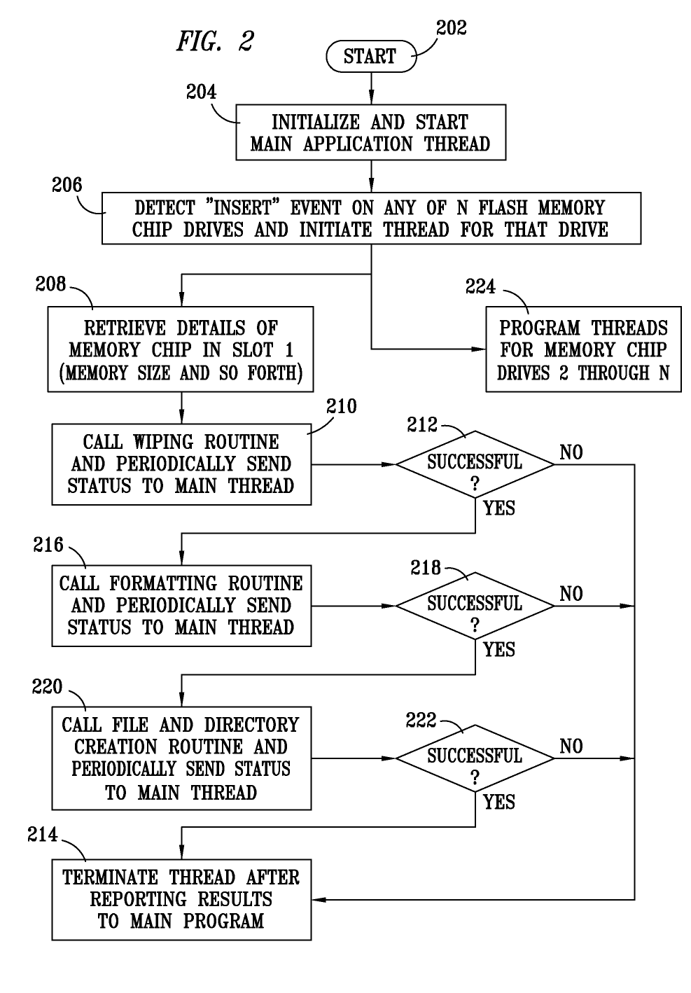

Reference will now be made to FIG. 2 in conjunction with FIGS. 1 and 3. In FIG. 2, a high level flow diagram commences with a start block 202 passing to a block 204 wherein the microprocessor 302 associated with the memory chip ports and display of FIGS. 1 and 3 is initialized and the main application thread for a sanitizing operation or procedure is commenced. The microprocessor 302 then either idles or works on other processes until a memory chip reader, such as reader 106, detects the insertion of a memory chip card such as 126. When such a card is inserted, the reader sends an IRQ (Interrupt ReQuest) or other microprocessor alert signal to the microprocessor 302. While the reader illustrated requires insertion, any form of initial communication between a memory card and a chip reader, such as infrared signals or other wireless communication may be used to actuate the alert signal. This IRQ is detected as an “insert” or initial communication event as set forth in a next step block 206. This causes the microprocessor to initiate a child thread for the reader sending the IRQ. Since it was assumed that the IRQ was sent by reader 1, the next step, in block 208, is to retrieve any appropriate details relative to the inserted memory chip card such as unformatted memory size and so forth. The next step, set forth in block 210, is for the child thread to call a wiping or erasing routine from microprocessor 302 that would typically be stored in memory 318.

As previously mentioned, the wiping routine may be as simple as writing a logic “0” to each logic bit in the memory chip thereby totally erasing any prior formatting, directory and data bits. If required by the customer, the wiping routine may comprise many steps of writing alternate logic “1”s and logic “0”s to further hinder any attempts to retrieve previously written data. As is known to those skilled in the art, many different wiping algorithms are commercially available and may be used in place of the simple wiping procedure outlined above.

As set forth in block 210, the status of the wiping routine is periodically sent back to the main program thread by using a “delegate”. This periodically reported data is preferably used to initiate and update a bar graph presentation such as 156, the descriptive text such as shown in object 154 of display block 102 and a status indicator adjacent the associated reader such as light 134.

When the wiping routine of block 210 is terminated, a check is made, in a decision block 212, as to whether the wiping operation was successful as determined by a given coded message output by the routine. If it was not, the program thread passes to block 214 where the thread is terminated after reporting the results to the main program thread as determined by a coded message that indicates the type of error encountered by the wiping routine. An example of an error might be premature removal of memory chip from the device while another error might be inability to write to numerous data bit positions of the memory chip. When the thread is terminated prematurely, a message, such as shown in object 178 (FIG. 1), is presented on the display 102 for the reader or drive affected. It may be noted that, in some embodiments of the invention, it may be advantageous to re-initiate an unsuccessful wiping routine automatically for a fixed number of intervals to assure that the memory chip is not capable of being re-written prior to notification of system error to the user.

If, on the other hand, the decision block 212 determines that the wiping operation was successful, the next step, in a block 216, is to call a formatting routine and again periodically send status reports to the main program thread. Such reports will preferably result in a text message such as shown in object 166 and a substantially complete bar graph indication similar to that shown as 164. It may be noted that the formatting procedure is optional and is shown by way of example for completeness of disclosure. Further, the formatting procedure is typically completed very quickly and one has to watch the display very carefully to even see the text message shown in object 166. When the formatting routine is terminated, a decision block 218 is used to ascertain if the routine was successful. If not, the drive 1 child thread is again terminated in block 214 after reporting to the main program thread.

If, on the other hand, the formatting routine is successful, the next step, as set forth in a block 220, is to call the optional file and directory creation routine. As before, periodic status reports are returned to the main sanitizing program thread whereby an indicator, such as a bar graph, is updated in a manner similar to that shown as 170 and a text message similar to that shown in object 172 may be displayed. Typically the file and directory creation routine is completed very quickly and often will not be observed on the display 102.

When the file and directory routine is terminated, a check is made in a decision block 222 as to whether or not this routine was completed successfully. If not completed successfully, the drive 1 thread is terminated and a report is preferably made to the main program thread whereby a text message such as that shown in object 178 may be provided. If, on the other hand, the file and directory routine was completed successfully, the final step, as presented in block 214 is to report the successful completion and cause the termination of the drive 1 thread until a further card is inserted into reader 106. The report to the main thread after a successful sanitize procedure will preferably cause a text message similar to that shown in objects 160 and 176 and the background to be changed from an in-process notification (such as a yellow color) to a successful completion notification (such as a green color).

As indicated by a block 224, program threads similar to that just discussed may be generated for the remaining chip drives 2 through N.

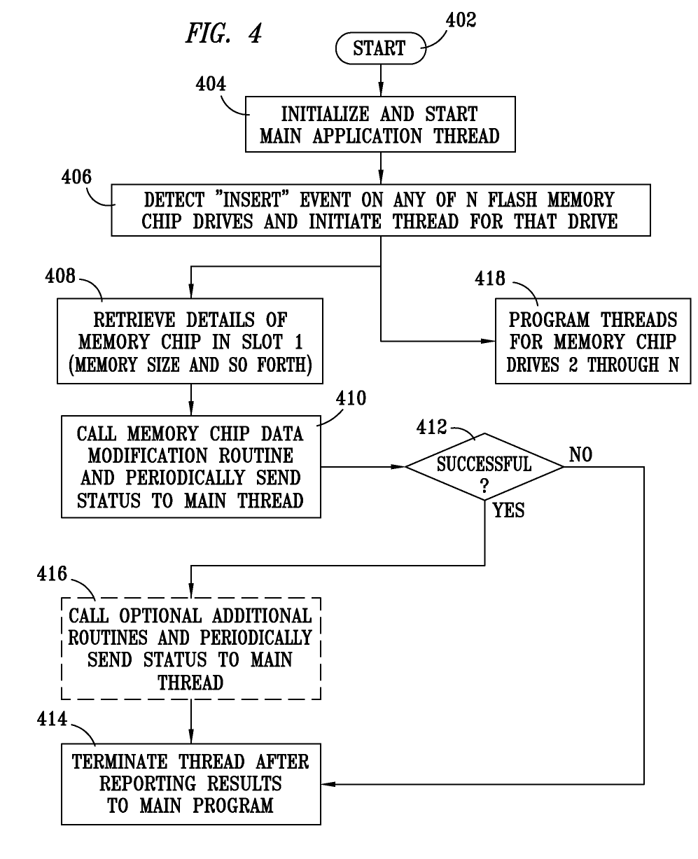

The flow chart of FIG. 4, is a more general presentation of the present invention in that it applies to any set of routines that may be applied to a plurality of individually processed memory chips. As an example, it may be desirable to check memory chips for known existing viruses before allowing same to be used on a network of computers. Alternatively, it may be desirable to check memory chips for defined programs or sensitive data before allowing same to be used on network computers. Similarly it may be required that security personnel check the contents of memory chips before allowing same to enter or exit a business establishment. As part of such a security check or otherwise, a device such as presented herein, may be used to add coded material to a memory chip whereby computers in a given area would only accept the memory chip as a valid drive upon detecting the coded material and/or a time restrictive password.

Reference will now be made to FIG. 4 in conjunction with FIGS. 1 and 3. In FIG. 4, a high level flow diagram commences with a start block 402 passing to a block 404 wherein the microprocessor 302 associated with the memory chip ports and display of FIGS. 1 and 3 is initialized and the main application thread for a memory chip data modification operation or procedure is commenced. The microprocessor 302 then either idles or works on other processes until a memory chip reading device, such as the drive 1 reader 106, detects the insertion of a memory chip such as 126. When such a chip card is inserted, the reader sends an IRQ or other microprocessor alert signal to the microprocessor 302. This alert signal is detected as a “insert” or initial communication event as set forth in a next step block 406. This causes the microprocessor to initiate a child thread for the reader sending the alert. Since it was assumed that the alert was sent by drive 1, the next step, in block 408, is to retrieve any details relative to the inserted memory chip card such as unformatted memory size and so forth. The next step, set forth in a block 410, is for the child thread to call a memory chip data modification or data checking routine from microprocessor 302 that would typically be stored in memory 318.

As previously mentioned, the routine may be quite varied and may comprise adding code, encrypting word processing files, checking for viruses and so forth.

As set forth in block 410, the status of the called routine is periodically sent back to the main program thread by using a “delegate”. This periodically reported data is used to initiate and update an indication, such as a bar graph, presentation such as 156, the descriptive text such as exemplified in object 154 of display block 102 and a status indicator adjacent the associated reader such as light 134.

When the called routine of block 410 is terminated, a check is made, in a decision block 412, as to whether the operation was successful. If it was not successful, the program thread passes to a block 414 where the thread is terminated after reporting the results to the main program thread. When the thread is terminated prematurely, a message, similar to that shown in object 178, may be presented on the display 102 for the reader or drive affected.

If, on the other hand, the decision block 412 determines that the operation of block 410 was successful, the next step, unless there are further optional operations to be performed as shown in a dash line block 416, is to proceed to block 414 and terminate the drive 1 thread after providing a successful operation report to the main program.

The report to the main thread after a successful sanitize procedure will preferably cause a text message somewhat similar to that exemplified in object 160, except that it will refer to the actual procedure last performed, and the background to be changed from an in-process notification (such as a yellow color) to a successful completion notification (such as a green color)

As indicated by a block 418, program threads similar to that just discussed may be generated for the remaining chip drives 2 through N.

In summary, the present invention comprises multichip reading and control apparatus for detecting the insertion of a memory chip into an unoccupied drive port and commencing the appropriate data bit processing of the inserted memory chip such as sanitation or other data bit modification. The design of the apparatus is such that it can commence an operation on a recently inserted memory chip while continuing the presently ongoing chip data modification procedures of one or more previously inserted memory chips. The apparatus is further configured to optionally provide additional procedures upon the successful completion of any initial memory chip data bit modification procedure.

While the first embodiment illustrated and described above is directed to sanitizing a memory chip, the multithread process approach, of this invention, is equally applicable to other data modifying procedures as set forth in FIG. 4. By way of example, one or more types of data files on memory chips may be encrypted. Likewise, such a device may be used to remove viruses, or check memory chips entering or leaving an establishment to prevent the passage of programs or sensitive data into or out of the establishment.

It should also be noted that, while a preferred embodiment of the invention used a recent memory chip insertion detection technique of detecting an IRQ, as an “insert event”, to reduce the load on a CPU (central processing unit), other detection techniques for ascertaining an “insert event” are readily available to a computer programmer. As an example, the CPU may maintain a table of memory chips presently inserted in given ports of the computer device by periodically checking the status of each of the given ports. When a change in memory chip port presence status is noted, the table may be updated. Thus the CPU may readily detect, determine or otherwise ascertain when a new chip is inserted in those given ports. Other techniques may also be used for ascertaining that a chip has been inserted since a prior periodic check, such as inserting a time stamp on a memory chip whose data bits are presently being modified.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features Many such variations and modifications may be considered desirable by those skilled in the art based upon a review of the foregoing description of preferred embodiments. Accordingly, it is appropriate that the appended claims be construed broadly and in a manner consistent with the scope of the invention.

1. Solid state storage device data bit modifying apparatus comprising:
a plurality of solid state storage device reading ports, each solid state storage device reading port being operable to output an alert signal indicative of initial readable communication with a solid state storage device;
a controller, connected to communicate with said plurality of solid state storage device reading ports;
circuitry configured for performing a first procedure operable to modify solid state storage device data bits of solid state storage devices that are in data transfer communication with respective ones of said plurality of solid state storage device reading ports; and
circuitry configured for initiating the performance of a second solid state storage device data bit modifying procedure upon a determination by said controller that a respective solid state storage device reading port of said plurality of solid state storage device reading ports is in initial communication with a solid state storage device while continuing to complete said first procedure.

2. Solid state storage device apparatus as claimed in claim 1 wherein:
said solid state storage devices are memory chips;
said plurality of memory chip reading ports comprises at least one of memory chip card reader and USB interface adapted for connection to a memory stick;
said circuitry includes means for initiating a new memory chip data bit modifying procedure thread upon said controller determining that a respective memory chip reading port of said plurality of memory chip reading ports is in initial communication with a memory chip; and
said new procedure threads are configured to call at least a memory sanitizing program.

3. Apparatus as claimed in claim 1 wherein said solid state storage devices are memory chips and further comprising:
a plurality of indicators, associated respectively with each of said plurality of memory chip reading ports; and
circuitry configured for connecting said controller to each of said indicators, said controller being further configured for providing control output signals, whereby the state of said indicators is representative of the status of the data bit modifying procedure of a memory chip in communication with a given memory chip reading port.

4. Apparatus as claimed in claim 1 wherein:
said controller is a computer processor;
said circuitry includes means for initiating a new solid state storage device data bit modifying procedure thread upon said controller being signaled that a given solid state storage device reading port of said plurality of solid state storage device reading ports is in initial communication with a solid state storage device; and
said apparatus additionally comprises a plurality of indicators, associated with each of said plurality of solid state storage device reading ports, said indicators providing an indication of the status of the data bit modifying procedure of a solid state storage device in communication with a given solid state storage device reading port.

5. A computer based method of solid state storage device data bit manipulation comprising steps of:
actuating a main data bit manipulation computer program that is capable of initiating a plurality of sub-routine data bit manipulation threads, each of said threads operating substantially independently;
supplying an initial communication event signal to said main data bit manipulation computer program when a given solid state storage device reader initially establishes communication with a solid state storage device; and
initiating a new data bit manipulation child routine thread for controlling any given solid state storage device reader initially establishing communication with a solid state storage device while maintaining other data bit manipulation child threads for any other solid state storage device readers whose data bit manipulation routine procedures are still in progress.

6. The method of claim 5 wherein the data bit manipulation comprises a procedure for sanitizing the solid state storage device.

7. The method of claim 5 further comprising a step of:
providing an indication of the status of a data bit manipulation thread for any given solid state storage device reader.

8. The method of claim 6 further comprising a step performed by a subprogram sanitizing thread of calling at least one of a formatting routine and a file and directory routine after a successful completion of a called sanitization routine.

9. The method of claim 6 further comprising a step performed by each sanitization child thread of providing periodic reports of sanitization progress to the main computer program.

10. Computer system apparatus comprising:
a processor;
a plurality of memory chip reading ports;
memory chip data bit modification procedure status indicators;
circuitry for communicating signals between said processor, said indicators and any memory chip reading ports in communication with memory chips; and
a multi-thread-capable computer program operable to initiate a new memory chip child thread for actuating a data bit modification procedure for a memory chip in initial communication with one of said plurality of memory chip readers, while continuing the data bit modification process of any memory chips whose data bit modification procedure has been previously started but not yet completed.

11. A programmed computer implemented method comprising;
initiating a new data bit alteration procedure thread upon a determination that a given memory chip reader has been placed in initial communication with a memory chip while other previously started data bit alteration procedure threads of the computer program continue in operation;
providing procedure status information for display to a user; and
terminating any completed or interrupted data bit alteration procedure threads.

12. The method of claim 11 wherein the determination is accomplished in response to a received alert signal from a given memory chip reader to a CPU.
